(19) United States
(12) Patent Application Publication
(10) Pub. No.: US 2017/0029132 A1
(43) Pub. Date: Feb. 2, 2017

(54) AIRCRAFT ENGINE WITH A FUEL SUPPLY APPLIANCE AND WITH AT LEAST ONE HYDRAULIC FLUID CIRCUIT THAT COMPRISES A HYDRAULIC FLUID RESERVOIR AND WITH A HEAT EXCHANGER

(71) Applicant: Rolls-Royce Deutschland Ltd & Co KG, Blankenfelde-Mahlow (DE)

(72) Inventors: Juergen BEIER, Schulzendorf (DE); Michael SCHACHT, Berlin (DE)

(21) Appl. No.: 15/220,646

(22) Filed: Jul. 27, 2016

(30) Foreign Application Priority Data
Jul. 28, 2015 (DE) 10 2015 112 325.8

(51) Int. Cl. B64D 37/34; F02C 7/224; F28F 21/08; F01D 25/20; F28D 9/00; B64D 37/32; F02C 7/14

(52) U.S. Cl. CPC B64D 37/34; B64D 37/32; F02C 7/224; F02C 7/14; F01D 25/20; F28D 9/00; F28F 21/084; F05D 2220/323; F05D 2260/213; F28D 2021/0021

(57) ABSTRACT

An aircraft engine with a fuel supply appliance and with at least one hydraulic fluid circuit that includes a hydraulic fluid reservoir, and with a heat exchanger. In the area of the heat exchanger, thermal energy can be exchanged between the hydraulic fluid conducted inside the hydraulic fluid circuit and the fuel of the fuel supply appliance. The pressure inside the hydraulic fluid circuit is higher in the area of the heat exchanger than the pressure in the fuel supply appliance. The heat exchanger is connected to the hydraulic fluid reservoir. Outer walls of the heat exchanger and outer walls of the hydraulic fluid reservoir at least partially shield an overlap area between the heat exchanger and the hydraulic fluid reservoir against an environment of the heat exchanger and of the hydraulic fluid reservoir.

This application claims priority to German Patent Application DE102015112325.8 filed Jul. 28, 2015, the entirety of which is incorporated by reference herein.

The invention relates to an aircraft engine with a fuel supply appliance and with at least one hydraulic fluid circuit that comprises a hydraulic fluid reservoir and with a heat exchanger according to the kind as it has been defined more closely in the generic term of patent claim 1.

Apart from a fuel supply appliance, aircraft engines that are known from practice usually also have at least one hydraulic fluid circuit that is configured with at least one hydraulic fluid reservoir. In addition, such aircraft engines are respectively embodied with at least one heat exchanger, in the area of which thermal energy can be exchanged between the hydraulic fluid that is conducted inside the hydraulic fluid circuit and the fuel of the fuel supply appliance. In order to safely avoid any spilling of fuel into the hydraulic fluid circuit in the event of an error, the pressure inside the hydraulic fluid circuit is higher in the area of the heat exchanger than the pressure inside the fuel supply appliance.

Disadvantageously, the various abovementioned components of an aircraft engine are arranged in different areas that are located at a distance from each other inside a housing of an aircraft engine, and that are respectively coupled to each other via a plurality of conduits inside of which fuel or hydraulic fluid is conducted and which are embodied with a comparatively high length, which is why known aircraft engines are respectively characterized by high self-weight, entail high manufacturing costs and have a complex constructional design.

Thus, the present invention is based on the objective to create an aircraft engine that comprises structural components of low weight and that is easy to manufacture, and that also has a constructional design that is as simple as possible.

According to the invention, this objective is achieved with an aircraft engine having the features of patent claim 1.

The aircraft engine according to the invention comprises a fuel supply appliance and at least one hydraulic fluid circuit that comprises a hydraulic fluid reservoir, as well as one heat exchanger, in the area of which thermal energy can be exchanged between the hydraulic fluid that is conducted inside the hydraulic fluid circle and the fuel of the fuel supply appliance. The pressure inside the hydraulic fluid circuit is higher in the area of the heat exchanger than the pressure inside the fuel supply appliance.

According to the invention, the heat exchanger is connected to the hydraulic fluid reservoir, wherein outer walls of the heat exchanger and outer walls of the hydraulic fluid reservoir at least partially shield an overlap area between the heat exchanger and the hydraulic fluid reservoir against an environment of the heat exchanger and of the hydraulic fluid reservoir.

Due to this fact, the aircraft engine according to the invention can be embodied with shorter connecting lines at least in the area between the hydraulic fluid reservoir, the heat exchanger and the fuel supply appliance, and the aircraft engine according to the invention can be manufactured with lower self-weight as well as in a more cost-effective manner as compared to known aircraft engines. In addition, the self-weight as well as the manufacturing costs are reduced by virtue of the fact that, in the respective overlap area or overlay area, the heat exchanger and the hydraulic fluid reservoir can be designed with less of a need to secure them against mechanical damages and thermal loads. Therefore, the housing walls of the hydraulic fluid reservoir and/or of the heat exchanger can be respectively embodied with lesser wall thicknesses in the overlap area between the hydraulic fluid reservoir and the heat exchanger.

In an advantageous embodiment of the aircraft engine according to the invention, the outer walls of the hydraulic fluid reservoir and of the heat exchanger are respectively embodied in a fire-resistant manner. In this way it is ensured that the interior space of the heat exchanger as well as the interior space of the hydraulic fluid reservoir are sufficiently secured against thermal loads, should an error occur in the aircraft engine. Compared to known aircraft engines, in which the housing of the hydraulic fluid reservoir as well as the housing of the heat exchanger are entirely made of fire-resistant material, in the aircraft engine according to the invention, the hydraulic fluid reservoir and/or the heat exchanger connected thereto can be embodied with a limiting wall in the overlap area between the hydraulic fluid reservoir and the heat exchanger that has a low self-weight and that is constructionally simpler and more cost-effective as compared to a wall that is embodied in a fire-resistant manner.

In a further development of the aircraft engine according to the invention, which is also characterized by a low self-weight, an interior space of the hydraulic reservoir is separated from the interior space of the heat exchanger by a common wall, which is cost-effective and at the same time keeps material requirements low.

If the heat exchanger is connected to the hydraulic fluid reservoir via a flange appliance, the aircraft engine according to the invention can be mounted with little effort.

If the hydraulic fluid circuit comprises a hydraulic pump, with its suction side being at least connected to the hydraulic fluid reservoir and the conveyor side being connected to the heat exchanger, the hydraulic fluid can be conducted inside the hydraulic fluid circuit to the desired degree from the hydraulic fluid reservoir in the direction of the heat exchanger and through the same.

In a further development of the aircraft engine according to the invention, the hydraulic fluid that can be supplied by the hydraulic pump to the heat exchanger can be conducted on by the heat exchanger in the direction of bearing chambers of the aircraft engine. Thus, bearing units of the aircraft engine according to the invention that are arranged in the area of the bearing chambers can on the one hand be supplied with lubricants and can be temperature-controlled on the other hand.

If the suction side of the hydraulic pump is connected to an oil sump of an auxiliary device gear unit, the volume of the hydraulic fluid reservoir can be limited to the desired degree, and the hydraulic fluid that is provided in the area of the auxiliary device gear unit can be conducted through the heat exchanger and can be temperature-controlled to the desired degree.

In a further advantageous embodiment of the aircraft engine according to the invention that is characterized by a high integration depth, the auxiliary device gear can be impinged by hydraulic fluid unit via the hydraulic pump, starting from the heat exchanger.

If the suction side of the hydraulic pump is connected to bearing chambers of the aircraft engine, a hydraulic fluid volume that is present in the area of the bearing chambers can be conducted out from the area of the bearing chambers with little constructional effort.

If the conveyor side of the hydraulic pump is coupled to a hydraulic fluid reservoir, a hydraulic fluid volume that is for example discharged from the area of the bearing chambers via the hydraulic pump can be introduced directly into the hydraulic fluid reservoir, without first guiding it through the heat exchanger.

In another embodiment of the aircraft engine according to the invention that is characterized by a high integration depth, a further hydraulic fluid circuit with a further hydraulic fluid reservoir is provided, wherein a suction side of a hydraulic pump of the further hydraulic fluid circuit is connected to a further hydraulic fluid reservoir, and a conveyor side of the hydraulic pump is connected to the heat exchanger. In this embodiment of the aircraft engine according to the invention, there is the additional possibility of an exchange of thermal energy in the area of the heat exchanger between the fuel of the fuel supply appliance and the hydraulic fluid of the hydraulic fluid circuit and/or the hydraulic fluid of the further hydraulic fluid circuit, and of tempering the hydraulic fluid of the hydraulic fluid circuit and/or of the further hydraulic fluid circuit to the desired degree.

If the conveyor side of the hydraulic pump of the further hydraulic fluid circuit is connected via the heat exchanger to the generator of the aircraft engine, which is in turn coupled to the suction side of the hydraulic pump and the further hydraulic fluid reservoir, and in the area of which preferably electric energy can be generated, the generator can again be temperature-controlled through the hydraulic fluid conducted inside the further hydraulic fluid circuit in compliance with the requirements.

If the fuel supply appliance comprises a fuel pump unit, via which fuel from a fuel storage can be conducted through the heat exchanger, the heat transfer in the area of the heat exchanger can be influenced to the desired degree.

If fuel can be conducted by the fuel pump unit from the heat exchanger in the direction of the fuel storage and in the direction of a fuel processing unit, as well as from there in the direction of an aircraft engine combustion chamber, any icing of a wing of an aircraft that accommodates the fuel storage of an aircraft can for example be avoided with little effort by means of a suitable temperature control of the fuel that is present inside the fuel storage, and the fuel can be conducted with a constant temperature, as it is necessary for providing constant operating conditions, in the direction of the aircraft engine combustion chamber, or it can be made available in this area with a constant operating temperature.

In a further embodiment of the aircraft engine according to the invention that is characterized by a high integration depth, at least one hydraulic fluid conduit that extends between the hydraulic fluid pump and the hydraulic fluid reservoir is integrated in the heat exchanger that represents a lid of the hydraulic fluid reservoir, in the hydraulic fluid reservoir that represents a lid of the heat exchanger and/or in an intermediate element that is arranged in the overlap area of the heat exchanger and the hydraulic fluid reservoir in between them and that is connected to them, whereby the hydraulic fluid reservoir and/or the heat exchanger can be embodied in a constructionally simple manner.

Furthermore, it is provided in one embodiment of the aircraft engine according to the invention which can be mounted with little effort that conduit areas are provided in the intermediate element, which respectively have interfaces with the heat exchanger, the hydraulic fluid reservoir, the hydraulic pump, the auxiliary device gear unit and/or the fuel supply appliance, depending on the respectively present application case.

In this case, such an intermediate element represents a so-called adapter element, via which, on the one hand, the mechanical connection in the area between the housings of the heat exchanger and the hydraulic fluid reservoir and, on the other hand, a fluidic coupling between the heat exchanger, the hydraulic fluid reservoir, the hydraulic pump, the auxiliary device gear unit and/or the fuel supply appliance can be realized.

Further, it can also be provided that the wall or limiting wall that separates the interior space of the heat exchanger from the interior space of the hydraulic fluid reservoir is a part of the intermediate element, which merely prevents any mixing of the hydraulic fluid that is guided inside the hydraulic fluid circuit with the fuel that is conducted in the area of the fuel supply appliance. An area of the intermediate element that is facing towards the environment of the heat exchanger and of the hydraulic fluid reservoir is then embodied so as to be correspondingly thermally and mechanically stable, preferably so as to be fire-resistant.

Further, there is also the possibility of the intermediate element being arranged between the heat exchanger and the hydraulic fluid reservoir in such a manner that the heat exchanger as well as the hydraulic fluid reservoir are only connected to the intermediate element, and thus are in operative connection with each other via the intermediate element. In addition, it can also be provided that the heat exchanger and the hydraulic fluid reservoir are either connected to each other directly or via the intermediate element, and that the intermediate element is arranged at least partially inside the heat exchanger and/or the hydraulic fluid reservoir.

The features that are specified in the patent claims as well as the features that are specified in the following exemplary embodiments of the aircraft engine according to the inventions are suitable to further develop the subject matter according to the invention respectively on their own or in any combination with each other.

Other advantages and advantageous embodiments of the aircraft engine according to the invention follow from the patent claims and the exemplary embodiments that are described in principle in the following by referring to the drawing, wherein, with a view to clarity, the same reference signs are respectively used for structurally and functionally identical structural components in the following description of the various exemplary embodiments.

Herein:

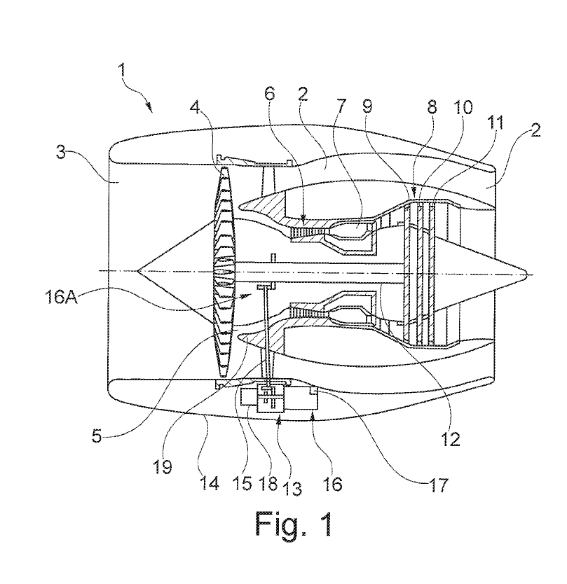

FIG. 1 shows a strongly schematized longitudinal section view of an aircraft engine with an auxiliary device gear unit that is arranged inside a housing;

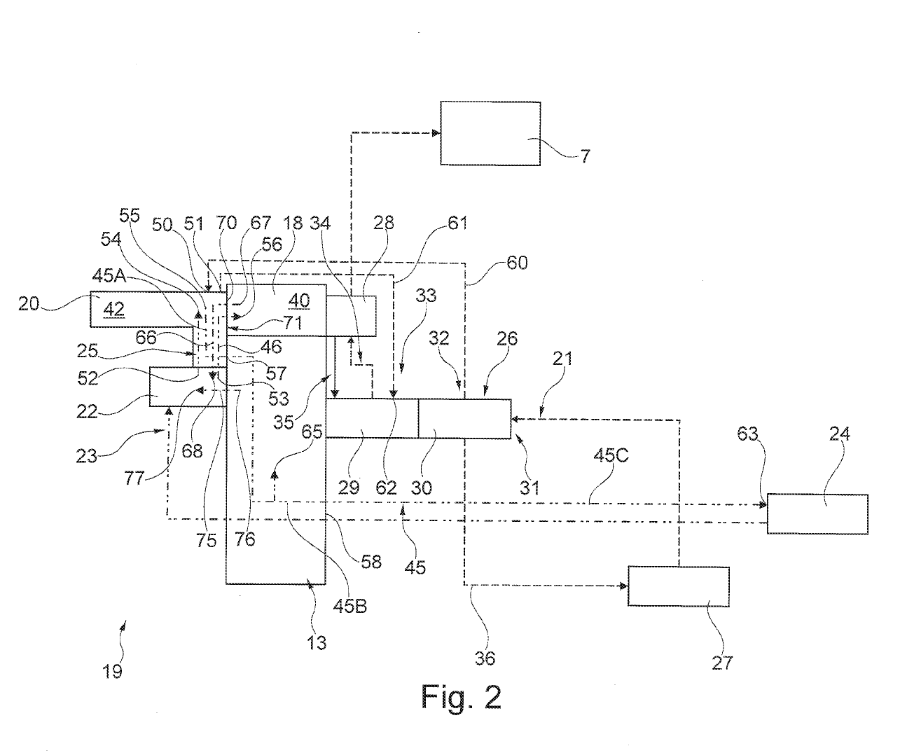

FIG. 2 shows a schematized representation of a hydraulic fluid circuit with a hydraulic fluid reservoir, with a fuel supply appliance and with a heat exchanger of the aircraft engine according to FIG. 1;

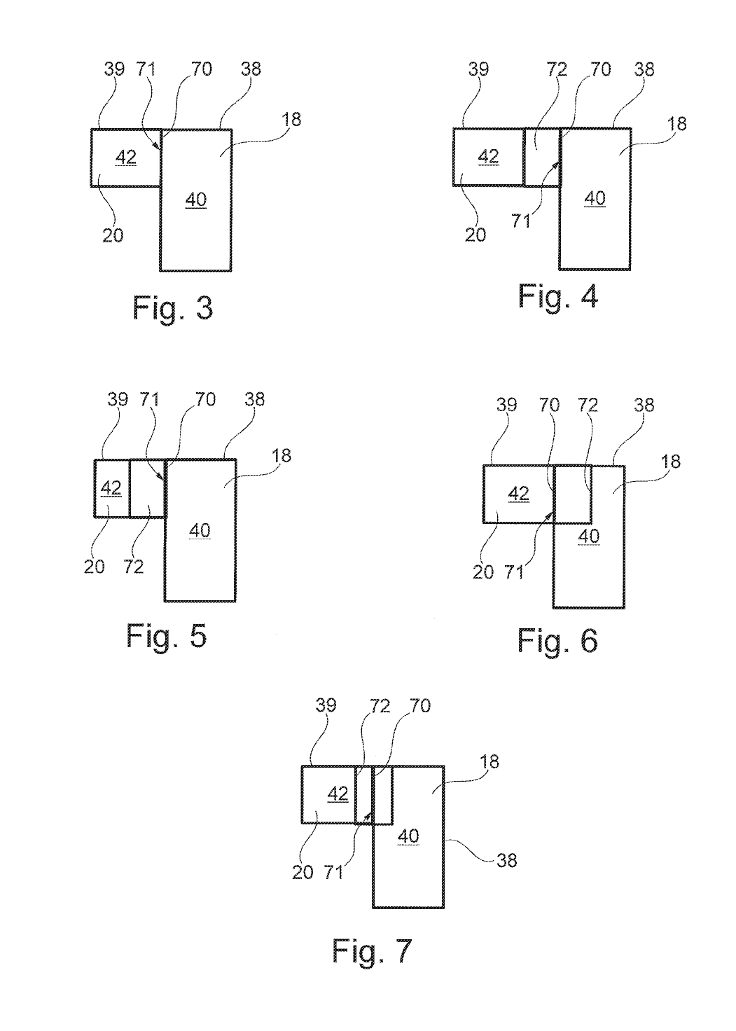

FIG. 3 to FIG. 7 show multiple strongly simplified representations of the heat exchanger, of the hydraulic fluid reservoir and of an optional intermediate element of different embodiments of the jet engine according to the invention;

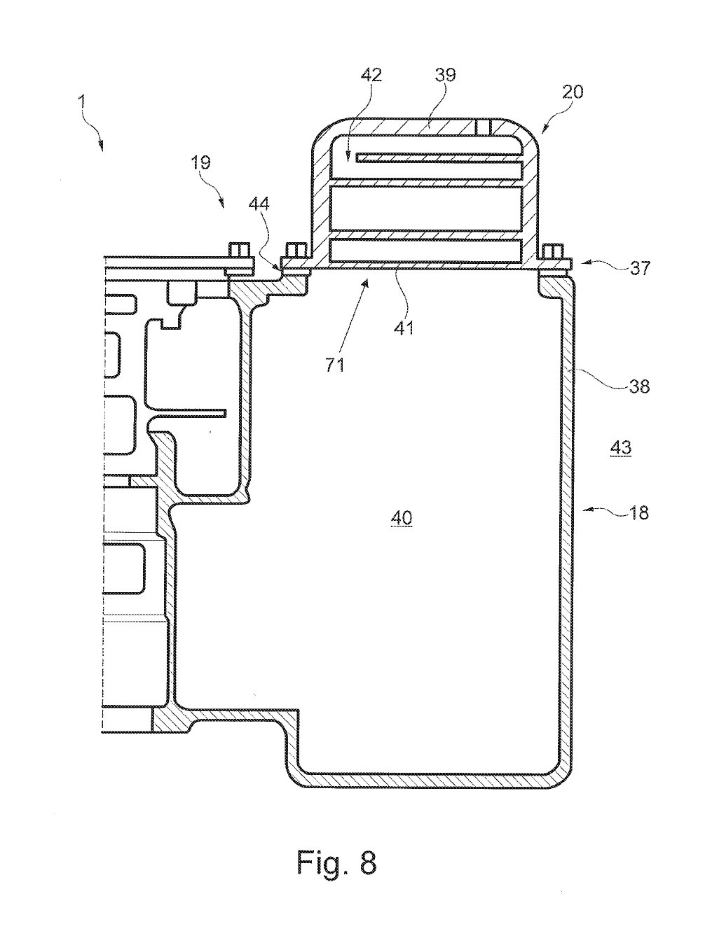

FIG. 8 shows a partial sectional view of the hydraulic fluid reservoir of the hydraulic fluid circuit and of the heat exchanger arranged thereat according to FIG. 2;

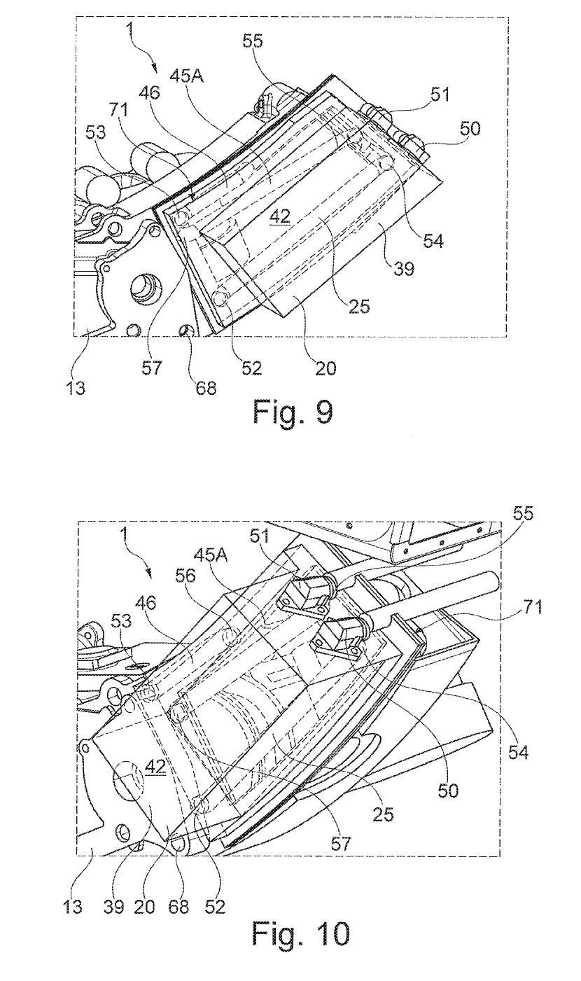

FIG. 9 shows a three-dimensional partially transparent representation of the heat exchanger according to FIG. 2 in a first view; and

FIG. 10 shows a representation of the heat exchanger that corresponds to FIG. 9 from a second view.

FIG. 1 shows an aircraft engine 1 in a longitudinal section view. The aircraft engine 1 is embodied with a bypass channel 2 and an inflow area 3, wherein a fan 4 connects downstream to the inflow area 3 in a per se known manner. Downstream of the fan 4 the fluid flow is in turn split inside the aircraft engine 1 into a bypass flow and a core flow, wherein the bypass flow flows through the bypass channel 2 and the core flow flows into the engine core 5, which is also embodied in a per se known manner with a compressor appliance 6, an aircraft engine combustion chamber or a burner 7 with an aircraft engine combustion chamber and a turbine appliance 8.

In the present case, the turbine appliance 8 has three rotor devices 9, 10 and 11, which are configured in a substantially comparable design and are connected to an engine axis 12.

An auxiliary device gear unit 13 is arranged inside an outer engine housing 14 that delimitates the bypass channel 2 and represents the outer circumferential area of the aircraft engine 1. In the present case, the auxiliary device gear unit 13 is connected to the engine axis 12 via a drive shaft 15 that extends in the radial direction of the aircraft engine 1 and via an inner gear 16A, and is thus driven or supplied with a torque by the engine axis 12 during operation of the aircraft engine 1. The auxiliary device gear unit 13 supplies torque to various ancillary units 16 as well as to an oil separator 17, which is also referred to as a breather, to a desired degree. In addition, an oil tank or a hydraulic fluid reservoir 18 is also provided in the area of the auxiliary device gear appliance 13, with hydraulic fluid for cooling and lubricating various areas of the aircraft engine 1 being extracted therefrom, such as for bearing appliances, gear wheel pairs of the inner gear 16A and of the auxiliary device gear unit 13, as well as for other assembly groups of the aircraft engine 1 that need to be cooled and lubricated.

For this purpose, the aircraft engine 1 is configured, to the extent as schematically shown in FIG. 2, with a hydraulic fluid circuit 19 that comprises the hydraulic fluid reservoir 18 and with a heat exchanger 20, in the area of which thermal energy can be exchanged between the hydraulic fluid that is conducted inside the hydraulic fluid circuit 19 and the fuel that is conducted in the area of a fuel supply appliance 21.

The pressure inside the hydraulic fluid circuit is lower in the area of the heat exchanger 20 or in the area of the fuel-conducting area of the heat exchanger 20 than in the hydraulic-fluid-conducting area of the heat exchanger 20 in order to reliably avoid possible leakages from the fuel supply appliance 21 in the direction of the hydraulic fluid circuit 19.

Apart from the hydraulic fluid reservoir 18, the hydraulic fluid circuit 19 comprises a hydraulic pump 22, with its suction side 23 being connected to the hydraulic fluid reservoir 18 via a conduit 66 that extends through the heat exchanger 20, to the auxiliary device gear unit 13 via a conduit 75 that extends through the heat exchanger 20, and to the bearing chambers 24 via a conduit 78. In addition, a conveyor side of the hydraulic pump 22 is connected to the heat exchanger 20 via a conduit 25, to the hydraulic fluid reservoir 18 via a conduit 46 that preferably extends through the heat exchanger 20, and moreover to the auxiliary device gear unit 13 and the bearing chambers 24 via the heat exchanger 20 and the conduit 45.

Here, the conduit 66 has an interface 68 to the hydraulic pump 22 and an interface 67 to the hydraulic fluid reservoir 18, while the conduit 75 is in operative connection in the area of an interface 76 to the auxiliary device gear unit 13, and is connected in the area of an interface 77 to the hydraulic pump 22. The conduit 25 extends between an interface 54 to the heat exchanger 20 and an interface 52 to the hydraulic pump 22. In addition, the conduit 46 has an interface 56 to the hydraulic fluid reservoir 18 and an interface 53 to the hydraulic pump 22.

Via an inlet area 55 of a first conduit area 45A of the conduit 45 connecting the heat exchanger 20 to the bearing chambers 24, hydraulic fluid reaches the first conduit area 45A in the area of the heat exchanger 20, with the first conduit area 45A extending from the heat exchanger 20 up to a further conduit section 45B that extends in the interior space of the auxiliary device gear unit 13 and has an interface 65 via which the ancillary gear appliance 13 is supplied with hydraulic fluid. In an area of an interface 57, the conduit 45 is conducted out from the heat exchanger 20 and into the interior space of the auxiliary device gear unit 13.

In the area of a further interface 58, the conduit 45 exits the interior of the auxiliary device gear unit 13 in the direction of the bearing chambers 24, wherein a third conduit section 45C of the conduit 45 opens into the bearing chambers 24 in the area of a further interface 63.

The fuel supply appliance 21 substantially represents a fuel circuit, which, apart from the fuel pump unit 26, comprises a fuel storage 27 and a fuel processing unit 28. In order to be able to conduct fuel that is stored in the area of the fuel storage 27 in the direction of the heat exchanger 20 as well as in the direction of the fuel processing unit 28, the fuel pump unit 26 comprises a high-pressure pump 29 and a low-pressure pump 30. A suction side 31 of the low-pressure pump 30 is connected to the fuel storage 27, while a conveyor side 32 of the low-pressure pump 30 is coupled to the heat exchanger 20 via a conduit 60, which opens into the heat exchanger 20 in the area 50. During operation of the aircraft engine 1, fuel is suctioned via the low-pressure pump 30 from the fuel storage 27 and is supplied via the conduit 60 to the heat exchanger 20. In the area of the heat exchanger 20, thermal energy is exchanged if a corresponding temperature gradient is present between the supplied fuel and the hydraulic fluid of the hydraulic fluid circuit 19 that is also supplied to the heat exchanger 20, wherein the hydraulic fluid that flows out of the heat exchanger 20 in the manner shown in FIG. 2 is conducted on to the auxiliary device gear unit 13 as well as to the bearing chambers 24.

The fuel volume flow that is also temperature-controlled in the area of the heat exchanger 20 is suctioned in the area of a suction side 33 of the high-pressure pump 29 via a conduit 61, which extends between an exit area 51 from the heat exchanger 20 and an entry area 62 of the high-pressure pump 29, and is supplied to the fuel processing unit 28 in the area of a conveyor side 34 of the high-pressure pump 29. Here, depending on the currently present fuel requirements, at least a part of the fuel that is made available by the high-pressure pump 29 and that is temperature-controlled in the area of the heat exchanger 20 is conducted on in the direction of the burner 7, while a fuel volume flow that is currently not required is supplied to the fuel pump unit 26 via a return conduit 35. In addition, the fuel pump unit 26 is in turn operatively connected to the fuel storage 27 at the conveyor side in the area of the low-pressure pump 30, whereby fuel that is also temperature-controlled in the area of the heat exchanger 20 can be introduced into the fuel storage 27 via a fuel return conduit 36.

FIG. 3 shows the hydraulic fluid reservoir 18 and the heat exchanger 20 that is arranged directly thereat in a strongly schematized form. In this embodiment of the aircraft engine 1, the heat exchanger 20 is fixedly connected in the area of its housing 39 to a housing 38 of the hydraulic fluid reservoir 18, preferably via a screw connection. A wall 70 that separates the interior space 42 of the heat exchanger 20 from the interior space 40 of the hydraulic fluid reservoir 18 is connected either to the housing 38 of the hydraulic fluid reservoir 18 or to the housing 39 of the heat exchanger 20. In addition, there is also the possibility of the heat exchanger 20 as well as the hydraulic fluid reservoir 18 having a wall that extends in the overlap area 71 between the heat exchanger 20 and the hydraulic fluid reservoir 18, which are abutting each other in the interconnected operating state of the heat exchanger 20 and of the hydraulic fluid reservoir 18.

Independently of whether the wall 70 is embodied as a part of the heat exchanger 20, as a part of the hydraulic fluid reservoir 18 or as a separate structural component, the wall 70 is embodied only with such a wall thickness as compared to the housing 38 of the hydraulic fluid reservoir 18 and of the housing 39 of the heat exchanger 20, that any spilling of hydraulic fluid from the hydraulic fluid circuit 19 into the fuel circuit of the aircraft engine 1 as well as any discharge of fuel from the fuel circuit of the aircraft engine 1 in the direction of the hydraulic fluid circuit 19 is reliably avoided, while the interior space 42 of the heat exchanger 20 and the interior space 40 of the hydraulic fluid reservoir 18 are protected to a necessary degree by the housing 39 of the heat exchanger 20 and by the housing 38 of the hydraulic fluid reservoir 40 against mechanical and thermal loads from the environment.

FIG. 4 shows a representation of a further embodiment of the aircraft engine 1 that corresponds to FIG. 3, in which an intermediate element 72 is arranged between the heat exchanger 20 and the hydraulic fluid reservoir 18, and inside of which e.g. the connecting lines between the hydraulic pump 22, the heat exchanger 20, the auxiliary device gear unit 13 and/or the hydraulic fluid reservoir 18, as they have been described in connection with FIG. 2, can be arranged at least in certain areas, which these respectively having interfaces to the heat exchanger 20, the hydraulic fluid reservoir 18, the hydraulic pump 22, the auxiliary device gear unit 13 and/or the fuel supply appliance 14.

In an embodiment that is shown in FIG. 4, the intermediate element 72 is arranged in the overlap area 71 between the heat exchanger 20 and the hydraulic fluid reservoir 18. The heat exchanger 20 is connected in the area of its housing 39 to the intermediate element 72, while the hydraulic fluid reservoir 18 is attached in the area of its housing 38 at the intermediate element 72, so that the heat exchanger 20 and the hydraulic fluid reservoir 18 form the desired unit via the intermediate element 72. The wall 70 that separates the interior space 42 of the heat exchanger 20 from the interior space 40 of the hydraulic fluid reservoir 18 can either be a part of the intermediate element 72 or a part of the hydraulic fluid reservoir 18, and is preferably provided in the abutment area 73 between the intermediate element 72 and the hydraulic fluid reservoir 18.

FIG. 5 again shows a further embodiment of the aircraft engine 1 in a representation that corresponds to FIG. 3, in which the housing 39 and 38 of the heat exchanger 20 and of the hydraulic fluid reservoir 18 are directly connected to each other. In the embodiment according to FIG. 5, the intermediate element 72 is arranged completely inside the interior space 42 of the heat exchanger 20 and is a separate structural component. In a further, alternative embodiment of the aircraft engine 1, which is shown in FIG. 6 and in which the heat exchanger 20 and the hydraulic fluid reservoir 18 are again directly connected to each other in the area of the housings 39 and 38, the intermediate element 72 is arranged in the interior space 40 of the hydraulic fluid reservoir 18 in the overlap area 71 between the heat exchanger 20 and the hydraulic fluid reservoir 18.

In still another embodiment of the aircraft engine according to the invention 1, the intermediate element 72 is arranged in the overlap area 71 between the heat exchanger 20 and the hydraulic fluid reservoir 18, with one part in the interior space of the heat exchanger 42 and with another part in the interior space 40 of the hydraulic fluid reservoir 18, wherein the heat exchanger 20 is again directly connected in the area of its housing 39 to the housing 38 of the hydraulic fluid reservoir 18.

Depending on the respectively present application case, there is also the possibility that, in a further development of the exemplary embodiment of the jet engine 1 that is shown in FIG. 4, the heat exchanger 20 is connected to the heat exchanger 20 via the intermediate element 72, and that the intermediate element 72 is arranged either partially in the interior space 42 of the heat exchanger 20, at least partially in the interior space 40 of the hydraulic fluid reservoir 18, or at least partially in the interior space 42 of the heat exchanger 20, and at least partially in the interior space 40 of the hydraulic fluid reservoir 18.

The heat exchanger 20 is arranged in the manner that is shown in FIG. 3 and FIG. 8 at the hydraulic fluid reservoir 18, or is screwed to the housing 38 of the hydraulic fluid reservoir 18 via a flange appliance 37. In the present case, the housing 38 of the hydraulic fluid reservoir 18 consists of a fire-resistant material and has a corresponding wall thickness. Further, the housing 38 is made of aluminum with a wall thickness of approximately 6 mm. A housing 39 of the heat exchanger 20 also consists of a fire-resistant material in certain areas, wherein in the present case the housing 39 of the heat exchanger 20 is also made of aluminum with a wall thickness of approximately 6 mm. Only a housing wall 41 of the heat exchanger 20 that delimitates an interior space 40 of the hydraulic fluid reservoir 18 and that separates an interior space 42 of the heat exchanger 20 from the interior space 40 and corresponds to the wall 70, is embodied with a lesser wall thickness in the present case, at the same time representing a part of the housing 38 of the hydraulic fluid reservoir 18 and of the housing 39 of the heat exchanger 20.

Due to the arrangement of the heat exchanger 20 at the hydraulic fluid reservoir 18, the housing wall 41 is impacted only by the pressure difference between the interior space 42 of the heat exchanger 20 and the interior space 40 of the hydraulic fluid reservoir 18. For this reason, the housing wall 41 can be embodied with a lesser wall thickness than the housing areas of the housing 38 and of the housing 39 that directly face the environment 43 of the hydraulic fluid reservoir 18 and of the heat exchanger 20, with the respective wall thicknesses having to be embodied so as to be considerably stronger in order to obtain pressure resistance and fire resistance.

A sealing appliance 44 is provided in the area of the flange appliance 37 between the housing 39 of the heat exchanger 20 and the housing 38 of the hydraulic fluid reservoir 18, through which the interior space 40 is sealed off against the environment 43.

The housing 39 of the heat exchanger 20 forms an area of the outer wall of the housing 38 of the hydraulic fluid reservoir 18 in the manner as it is shown in more detail in FIG. 8, so that the heat exchanger 20 as well as the hydraulic fluid reservoir 18 can be embodied by using less material and thus in a more cost-effective manner, while at the same time having low-weight structural components.

Generally, the housing 39 of the heat exchanger 20 and also the housing 38 of the hydraulic fluid reservoir 18 can be made of a fire-resistant material, which in technology are generally represented by materials with an application temperature of over 600° C. For example, it is possible to manufacture the housing 39 and the housing 38 from aluminum oxide, or also from other suitable alloys. Such so-called refractory materials are metallic and ceramic materials that show a certain thermal resistance at application temperatures of 600° C. to over 1700° C.

Depending on the respectively present application case, the heat exchanger 20 can be embodied as a continuous-current, counter-current or cross-flow heat exchanger of any desired constructional design, for example as a tube bundle heat exchanger, as a plate heat exchanger, or the like.

In addition, there is also the possibility of producing structural components of the hydraulic fluid circuit 19, the fuel supply appliance 21 and/or of the heat exchanger 20 in a cost-effective manner at least partially by means of a 3D printing method, such as LMD (laser metal deposition) or SLM (selective laser melting).

FIG. 9 and FIG. 10 respectively show a partially transparent representation of the heat exchanger 20 according to FIG. 2 and according to FIG. 3 in different views.

Depending on the respectively present application case, the conduits between the hydraulic pump, the hydraulic fluid reservoir, the heat exchanger and the auxiliary device gear unit are arranged so as to extend inside the heat exchanger and/or inside the intermediate element, establishing to the previously described extent the connections between the hydraulic pump, the hydraulic fluid reservoir, the heat exchanger, the bearing chambers and the auxiliary device gear unit via the respective interfaces.

### PARTS LIST

1 aircraft engine
2 bypass channel
3 inflow area
4 fan
5 engine core
6 compressor appliance
7 burner
8 turbine appliance
9, 10, 11 rotor device
12 engine axis
13 auxiliary device gear unit
14 engine housing
15 drive shaft
16 ancillary units
16A inner gear
17 oil separator
18 hydraulic fluid reservoir, oil tank
19 hydraulic fluid circuit
20 heat exchanger
21 fuel supply appliance
22 hydraulic pump
23 suction side of the hydraulic pump 22
24 bearing chambers
25 conveyor side of the hydraulic pump
26 fuel pump unit
27 fuel storage
28 fuel processing unit
29 high-pressure pump
30 low-pressure pump
31 suction side of the low-pressure pump
32 conveyor side of the low-pressure pump
33 suction side of the high-pressure pump
34 conveyor side of the high-pressure pump
35 return conduit
36 fuel return conduit
37 flange appliance
38 housing of the hydraulic fluid reservoir
39 housing of the heat exchanger
40 interior space of the hydraulic fluid reservoir
41 housing wall of the heat exchanger
42 interior space of the heat exchanger
43 environment
44 sealing appliance
45 conduit
45A to 45 C conduit areas of the conduit 45
46 hydraulic conduit
47 area of the heat exchanger
48 hydraulic conduit
50 area
51 exit area
52 interface
53 interface
54 interface
55 inlet area
56 to 58 interface
60 conduit
61 conduit
62 entry area
63 interface
65 interface
66 conduit
67, 68 interface
70 wall
71 overlap area
72 intermediate element
73 abutment area
75 conduit
76, 77 interface
78 conduit

1. An aircraft engine with a fuel supply appliance and with at least one hydraulic fluid circuit that comprises a hydraulic fluid reservoir and with a heat exchanger, in the area of which thermal energy can be exchanged between the hydraulic fluid that is conducted inside the hydraulic fluid circuit and the fuel of the fuel supply appliance, wherein the pressure inside the hydraulic fluid circuit is higher in the area of the heat exchanger than the pressure inside the fuel supply appliance, wherein the heat exchanger is connected to the hydraulic fluid reservoir, wherein outer walls of the heat exchanger and outer walls of the hydraulic fluid reservoir at least partially shield an overlap area between the heat exchanger and the hydraulic fluid reservoir against an environment of the heat exchanger and of the hydraulic fluid reservoir.

2. The aircraft engine according to claim 1, wherein the outer wall of the hydraulic fluid reservoir and of the heat exchanger are respectively embodied in a fire-resistant manner.

3. The aircraft engine according to claim 1, wherein an interior space of the hydraulic reservoir is separated from the interior space of the heat exchanger by a common wall.

4. The aircraft engine according to claim 1, wherein the heat exchanger is connected to the hydraulic fluid reservoir via a flange appliance.

5. The aircraft engine according to claim 1, wherein the hydraulic fluid circuit has a hydraulic pump, with its suction side being connected at least to the hydraulic fluid reservoir and its conveyor side being connected to the heat exchanger.

6. The aircraft engine according to claim 5, wherein the hydraulic fluid that can be supplied to the heat exchanger by the hydraulic pump can be conducted on from the heat exchanger in the direction of bearing chambers of the aircraft engine.

7. The aircraft engine according to claim 5, wherein the suction side of the hydraulic pump is connected to an oil sump of an auxiliary device gear unit.

8. The aircraft engine according to claim 7, wherein the auxiliary device gear unit can be impinged by hydraulic fluid via the hydraulic pump, starting from the heat exchanger.

9. The aircraft engine according to claim 6, wherein the suction side of the hydraulic pump is connected to the bearing chambers of the aircraft engine.

10. The aircraft engine according to claim 5, wherein the conveyor side of the hydraulic pump is coupled to the hydraulic fluid reservoir.

11. The aircraft engine according to claim 1, wherein a further hydraulic fluid circuit with a further hydraulic fluid reservoir is provided, wherein a suction side of a hydraulic pump of the further hydraulic fluid circuit is connected to a further hydraulic fluid reservoir and a conveyor side of the hydraulic pump is connected to the heat exchanger.

12. The aircraft engine according to claim 11, wherein the conveyor side of the hydraulic pump of the further hydraulic fluid circuit is connected via the heat exchanger to a generator of the aircraft engine, which in turn is coupled to the suction side of the hydraulic pump and to the further hydraulic fluid reservoir.

13. The aircraft engine according to claim 1, wherein the fuel supply appliance comprises a fuel pump unit, via which fuel can be conducted from the fuel storage through the heat exchanger.

14. The aircraft engine according to claim 13, wherein fuel can be conducted by the fuel pump unit from the heat exchanger in the direction of the fuel storage and in the direction of a fuel processing unit, and from there also in the direction of an aircraft engine combustion chamber.

15. The aircraft engine according to claim 5, wherein at least one hydraulic fluid conduit that extends between the hydraulic pump and the hydraulic fluid reservoir is integrated in the heat exchanger that represents a lid of the hydraulic fluid reservoir.
